(19) United States
(12) Patent Application Publication
(10) Pub. No.: US 2026/0142235 A1
(43) Pub. Date: May 21, 2026

(54) Sulfonamide-Based Electrolyte Additives For Electrochemical Batteries

(71) Applicant: SES Holdings Pte. Ltd., Singapore (SG)

(72) Inventors: Yijie Yin, Medford, MA (US); William G. Crisp, Boston, MA (US); Luke Schkeryantz, Sommerville, MA (US); Bin Liu, Lexington, MA (US); Hong Gan, Woburn, MA (US)

(21) Appl. No.: 19/387,808

(22) Filed: Nov. 13, 2025

Related U.S. Application Data
(60) Provisional application No. 63/722,267, filed on Nov. 19, 2024.

(51) Int. Cl. H01M 10/0567; H01M 4/02; H01M 4/38; H01M 10/0525; H01M 10/0568; H01M 10/0569; H01M 10/058

(52) U.S. Cl. CPC H01M 10/0567; H01M 4/381; H01M 10/0525; H01M 10/0568; H01M 10/0569; H01M 10/058; H01M 2004/027

(57) ABSTRACT

Additives that decompose during charging of alkali-metal battery and alkali-ion battery cells such that the additives form part of the SEI layer and the CEI layer are provided for adding to electrolytes in such cells. Sulfonamide-based compounds may be used as additives into baseline electrolytes for alkali metal and alkali-ion batteries. As electrolyte additives, these compounds promote the formation of inorganic-rich solid electrolyte interphases and passivates electrode interfaces, resulting in improved battery performance. Solvents for the baseline electrolyte may include carbonate-based, ether-based, ester-based, sulfone-based, sulfonated-based, nitrile-based, sulfonamide-based, phosphate-based, ionic liquids, and mixtures thereof. These solvents may be non-fluorinated or fluorinated. The percent weight of solvent with respect to the total weight of the electrolyte may be from 0.05 wt % to 99 wt %, and preferably from 10 wt % to 90 wt %.

### RELATED APPLICATION DATA

This application claims the benefit of priority of U.S. Provisional Patent Application Ser. No. 63/722,267, filed on Nov. 19, 2024, and titled “Sulfonamide-Based Electrolyte Additives For Electrochemical Batteries,” which is incorporated by reference herein in its entirety.

### FIELD

The present disclosure generally relates to electrolytes for electrochemical batteries. In particular, the present disclosure relates to electrolyte additives for electrochemical batteries.

### BACKGROUND

The development of advanced battery technologies is crucial for a wide range of applications, from consumer electronics to electric vehicles and renewable energy storage. Traditional lithium-ion batteries, while widely used, face several challenges including limited energy density, safety concerns, and performance degradation over time. Lithium metal is regarded as one of the most promising energy storage solutions since it can have a gravimetric energy density of more than 500 w/kg. However, in electrochemical batteries lithium metal suffers from the continuous formation of unstable solid-electrolyte interphases (SEIs), which can lead to capacity loss and increased internal resistance over cycling.

Materials and additives that could enhance the stability and efficiency of electrochemical batteries have been researched, including electrolyte additives, as described in, for example, U.S. Pat. Pub. 20230108463, China Pat. 114899492-A, China Pat. 113363583-B, China Pat. 116565316-A, and China Pat. 115579523-A. Despite these efforts, a need remains for materials that can provide these benefits without compromising other performance metrics of electrochemical batteries, including lithium metal batteries.

### SUMMARY OF THE DISCLOSURE

An electrolyte for an electrochemical device having an alkali-metal anode having an anode-active material comprising an alkali metal is provided that includes a carbonate-based, ether-based, or sulfonamide-based solvent, at least one alkali-metal salt dissolved in the solvent, the alkali-metal salt having a cation comprising the alkali metal of the anode-active material, and at least one electrolyte additive, each having the following general molecular structure:

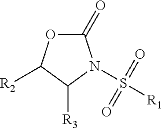

where R₁ is selected from the group of —F, —Cl, —Br, —I, —CₙHₘX₂ₙ₊₁₋ₘ, where X is F, Cl, Br, or I, n is any value selected from 1 to 3, and m is any value selected from 0 to 2n+1, and where R₂ and R₃, are independently selected from any of C₁-C₆ alkyl C_{z}H_{2z+1}, where z is any value from 0 to 6.

In another aspect, an electrolyte for an electrochemical device having an alkali-metal anode having an anode-active material comprising an alkali metal includes a carbonate-based, ether-based, nitrile-based, sulfonated-based, sulfone-based, ionic liquid-based, phosphate-based, or sulfonamide-based solvent, at least one alkali-metal salt dissolved in the solvent, the alkali-metal salt having a cation comprising the alkali metal of the anode-active material, and at least one electrolyte additive selected from a compound described herein present in a range of 0.25 wt % to 5 wt % of the electrolyte.

In another aspect, a method of preparing an electrochemical cell having an alkali-metal anode having an anode-active material comprising an alkali metal includes adding an electrolyte including a solvent, the solvent being a carbonate-based, ether-based, or sulfonamide-based solvent and at least one alkali-metal salt dissolved in the solvent, the alkali-metal salt having a cation comprising the alkali metal of the anode-active material, and adding at least one additive to the electrolyte, the additive selected such that the additive decomposes to form part of a solid-electrolyte-interphase (SEI) layer and a cathode-electrolyte-interphase (CEI) layer.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, wherein:

FIG. 1 is a graph of relative energies of highest occupied molecular orbital) and lowest unoccupied molecular orbital of certain compounds, some of which may be used as electrolyte additives in accordance with embodiments of the present disclosure;

FIG. 2 is a graph of cycle life versus cycle number for cells with the integration of OZSF into DMSF-based electrolytes compared to a baseline electrolyte;

FIG. 3 is a graph of nDCIR versus cycle number showing a reduction in nDCIR increases for cells with a hybrid electrolyte compared to cells with a baseline electrolyte as cycle number increases;

FIG. 4 is a graph of average charge voltage versus cycle number showing a reduction of increases in charge voltage for cells with OZSF integrated into DMSF-based electrolytes compared to cells having a baseline electrolyte without an additive; and

FIG. 5 is a graph of cycle life percent versus cycle number showing improvement of cycle life for cells with an electrolyte with OZSF and KFSI integrated into DMSF solvent compared to cells having a baseline electrolyte with the additive.

### DETAILED DESCRIPTION

Additives that decompose during charging of alkali-metal battery and alkali-ion battery cells such that the additives form part of the SEI layer and the CEI layer are provided for adding to electrolytes in such cells. In an embodiment, sulfonamide-based compounds are introduced as additives into baseline electrolytes for alkali metal and alkali-ion batteries. As electrolyte additives, these compounds promote the formation of inorganic-rich solid electrolyte interphases (SEIs) and passivates electrode interfaces, resulting in improved battery performance. In a preferred embodiment, the total concentration of such additives in the electrolyte may be from 0.01 M to 0.5 M.

Solvents for the baseline electrolyte may include carbonate-based, ether-based, ester-based, sulfone-based, sulfonated-based, nitrile-based, sulfonamide-based, phosphate-based, ionic liquids, and mixtures thereof. These solvents may be non-fluorinated or fluorinated. The percent weight of solvent with respect to the total weight of the electrolyte may be from 0.05 wt % to 99 wt %, and preferably from 10 wt % to 90 wt %. The percent weight of these additives with respect to the total weight of the electrolyte may be from 0.05 wt % to 99 wt %, and preferably from 0.25 wt % to 10 wt %.

In an embodiment, certain of these sulfonamide-based additives are compounds having the formula shown in Structure A, below, in which. R₁, can be any of —F, —Cl, —Br, —I, and —CₙHₘX₂ₙ₊₁₋ₘ (where X is F, Cl, Br, or I, where n is selected from 1 to 3, and where m is selected from 0 to 2n+1); and R₂ or R₃ can be any of C₁-C₆ alkyl; CₙH₂ₙ₊₁ (where n is selected from 0 to 6);

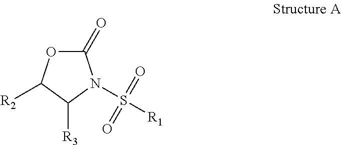

C₁-C₆ substituted alkyl; CₙHₘX₂ₙ₊₁₋ₘZₚ (where X is F, Cl, Br, or I, Z is O or S, n is selected from 0 to 6, m is selected from 0 to 2n+1, and p is selected from 0 to n−1); and —C₆H₅. R₂ can be the same as or different than R₃.

In another embodiment, certain of these sulfonamide-based additives are compounds having the formula shown in Structure B, below, in which R₁ can be any of —F, —Cl, —Br, —I, —CₙHₘX₂ₙ₊₁₋ₘ (where X is F, Cl, Br, or I, n is selected from 1 to 3, and m is selected from 0 to 2n+1; and R₂, R₃, and R₄ can be independently any of C₁-C₆ alkyl CₙH₂ₙ₊₁, where n is selected from 0 to 6; R₂ or R₃, can be any of C₁-C₆ alkyl; C₁-C₆ substituted alkyl; CₙHₘX₂ₙ₊₁₋ₘZₚ (where X is F, Cl, Br, or I and Z is O or S, n is selected from 0 to 6, m is selected from 0 to 2n+1, and p is selected from 0 to n−1); R₂, R₃ or R₄ could be —C₆H₅. R₂ can be the same as or different than R₃ or R₄. R₃ can be the same as or different than R₄.

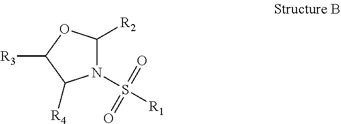

In another embodiment, certain of these sulfonamide-based additives are compounds having the formula shown in Structure C, below, in which R₁, can be any of —F, —Cl, —Br, —I, —CₙHₘX₂ₙ₊₁₋ₘ (where X is F, Cl, Br, or I, n is selected from 1 to 3, and m is selected from 0 to 2n+1); R₂, R₃, and R₄ can be independently any of C₁-C₆ alkyl; CₙH₂ₙ₊₁, where n is selected from 0 to 6; R₂ or R₃, can be any of C₁-C₆ alkyl, C₁-C₆ substituted alkyl; CₙHₘX₂ₙ₊₁₋ₘZₚ (where X is F, Cl, Br, or I, Z is O or S, n is selected from 0 to 6, m is selected from 0 to 2n+1, and p is selected from 0 to n−1; R₂, R₃ or R₄ could be —C₆H₅. R₂ can be the same as or different than R₃ or R₄. R₃ can be the same as or different than R₄.

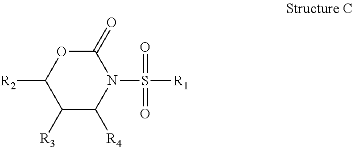

In another embodiment, certain of these sulfonamide-based additives are compounds having the formula shown in Structure D, below, in which R₁, can be any of —F, —Cl, —Br, —I, —CₙHₘX₂ₙ₊₁₋ₘ (where X is F, Cl, Br, or I, n is selected from 1 to 3, and m is selected from 0 to 2n+1; R₂ or R₃ can be any of C₁-C₆ alkyl; CₙH₂ₙ₊₁, where n is selected from 0 to 6; R₂ or R₃ can be any of C₁-C₆ alkyl, C₁-C₆ substituted alkyl, CₙHₘX₂ₙ₊₁₋ₘZₚ (where X is F, Cl, Br, or I, Z is O or S, n is selected from 0 to 6, m is selected from 0 to 2n+1, and p is selected from 0 to n−1; and R₂ or R₃ could be —C₆H₅. R₂ can be the same as or different than R₃ or R₄. R₃ can be the same as or different than R₄.

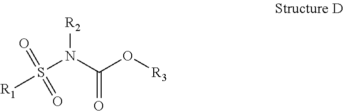

In another embodiment, certain of these sulfonamide-based additives are compounds having the formula shown in Structure E, below, in which R₁, can be any of —F, —Cl, —Br, —I, —CₙHₘX₂ₙ₊₁₋ₘ (where X is F, Cl, Br, or I, n is selected from 1 to 3, and m is selected from 0 to 2n+1; R₂, R₃, and R₄ can be independently any of C₁-C₆ alkyl; CₙH₂ₙ₊₁, where n is selected from 0 to 6; R₂ or R₃ can be any of C₁-C₆ alkyl, C₁-C₆ substituted alkyl; CₙHₘX₂ₙ₊₁₋ₘZₚ (where X is F, Cl, Br, or I, Z is O or S, n is selected from 0 to 6, m is selected from 0 to 2n+1, and p is selected from 0 to n−1; and R₂, R₃ or R₄ can be —C₆H₅. R₂ can be the same as or different than R₃ or R₄. R₃ can be the same as or different than R₄.

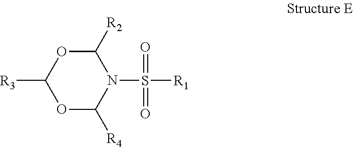

In accordance with other embodiments, any of the above Structures A-E may be introduced as an additive into a baseline electrolyte for an alkali metal or alkali-ion battery, a lithium-ion battery, a potassium-ion battery, or a magnesium-ion battery. These compounds, when used as electrolyte additives for such batteries, may promote the formation of inorganic-rich SEIs on an anode, where the anode may be, for example, graphite, silicon, or a graphite-silicon composite.

### Example Additive Compounds

As noted, Structure A has the formula:

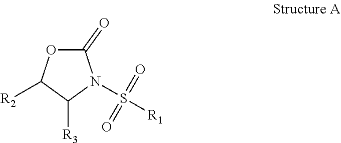

The following are example compounds having Structure A: Example A1, below, 2-oxooxazolidine-3-sulfonyl fluoride, where R₁ is —F, R₂ is —H, and R₃ is —H; Example A2, below, 3-[(Trifluoromethyl) sulfonyl]-2-oxazolidinone, where R₁ is —CF₃, R₂ is —H, and R₃ is —H; Example A3, below, 2-oxo-4-(trifluoromethyl) oxazolidine-3-sulfonyl fluoride, where R₁ is —F, R₂ is —H, and R₃ is —CF₃; Example A4, below, 4-methyl-2-oxooxazolidine-3-sulfonyl fluoride, where R₁ is —F, R₂ is —H, and R₃ is —CH₃; Example A5, below, where R₁ is —F, R₂ is —H, and R₃ is —C₆H₅; and Example A6, below, where R₁ is —F, R₂ is —H, and R₃ is —CF₂H.

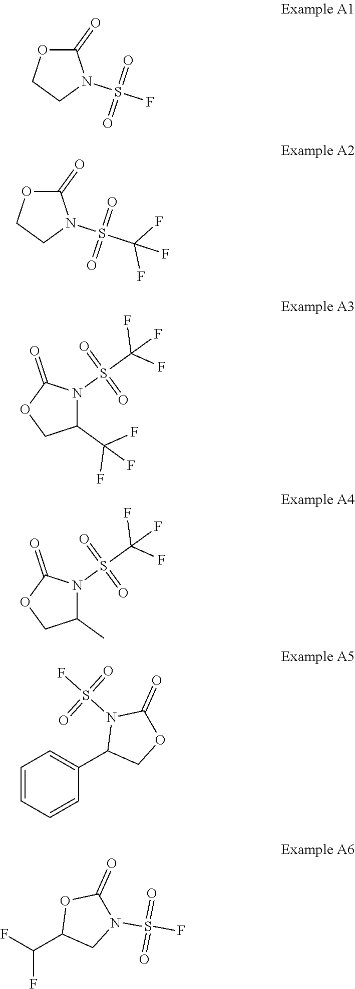

As noted, Structure B has the formula:

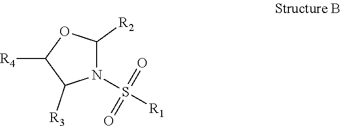

The following are example compounds having Structure B: Example B1 (oxazolidine-3-sulfonyl fluoride), below, where R₁ is —F, R₂ is —H, R₃ is —H, and R₄ is —H; Example B2 (3-((trifluoromethyl) sulfonyl) oxazolidine), below, where R₁ is —CF₃, R₂ is —H, R₃ is —H, and R₄ is —H; Example B3 (4-(trifluoromethyl) oxazolidine-3-sulfonyl fluoride), below, where R₁ is —F, R₂ is —H, R₃ is —H, and R₄ is —CF₃; and Example B4, below, where R₁ is —F, R₂ is —CH₃, R₃ is —H, and Ra is —H.

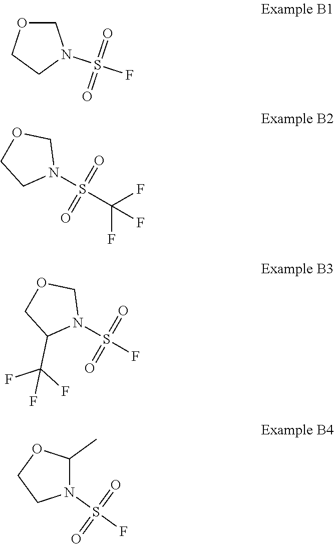

As noted, Structure C has the formula:

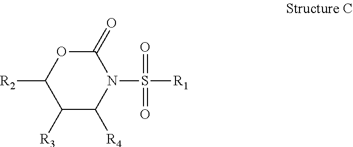

The following are example compounds having Structure C: Example C1 (2-oxo-1,3-oxazinane-3-sulfonyl fluoride), below, where R₁ is —F, R₂ is —H, R₃ is —H, and R₄ is —H; Example C2 (3-((trifluoromethyl) sulfonyl)-1,3-oxazinan-2-one), below, where R₁ is —CF₃, R₂ is —H, R₃ is —H, and R₄ is —H; and Example C3, below, where R₁ is —F, R₂ is —H, R₃ is —CF₂H, and Ra is —H.

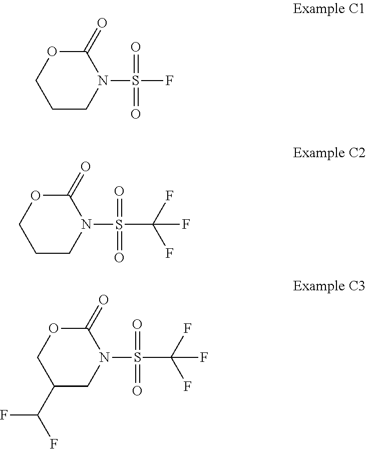

As noted, Structure D has the formula:

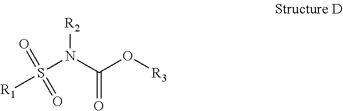

The following are example compounds having Structure D: Example D1 (methyl (fluorosulfonyl)(methyl) carbamate), below, where R₁ is —F, R₂ is —CH₃, and R₃ is —CH₃; Example D2 (ethyl methyl((trifluoromethyl) sulfonyl) carbamate), below, where R₁ is —CF₃, R₂ is —CH₃, and R₃ is —CH₃; and Example D3, below, where R₁ is —F, R₂ is —CH₃, and R₃ is —CF₃.

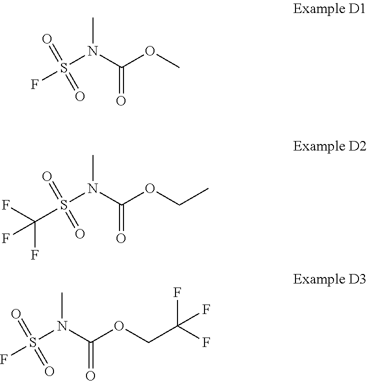

As noted, Structure E has the formula:

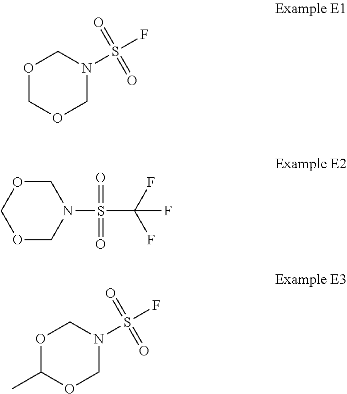

The following are example compounds having Structure E: Example E1 (1,3,5-dioxazinane-5-sulfonyl fluoride), below, where R₁ is —F, R₂ is —H, R₃ is —H, and R₄ is —H; Example E2 (5-((trifluoromethyl) sulfonyl)-1,3,5-dioxazinane), below, where R₁ is —CF₃, R₂ is —H, R₃ is —H, and R₄ is —H; and Example E3, below, where R₁ is —F, R₂ is —H, R₃ is —CH₃, and R₄ is —H.

### Example Hybrid Electrolytes

Any of the above example compounds, as well as or including any of 2-oxo-3-oxazolidinesulfonyl fluoride (OZSF), 2-oxo-3-oxazolidinesulfonyl fluoride (ODSF), 2-oxo-1,3-oxazinane-3-sulfonyl fluoride (OASF), methyl (fluorosulfonyl)(methyl) carbamate (MEFS), and 1,3,5-dioxazinane-5-sulfonyl fluoride (DZSF), may be added to a baseline electrolyte for a lithium metal battery, lithium-ion battery or similar battery, where the solvent can be a carbonate-based, ether-based, or sulfonamide-based solvent, or mixtures thereof.

In some embodiments, one or more of the following salts can be combined with any of the above additives and solvents to form a hybrid electrolyte of the present disclosure: lithium sulfonyl imide, lithium bis(fluorosulfonyl)imide (LiFSI), lithium bis(trifluoromethane-sulfonyl)imide (LiTFSI), lithium (fluorosulfonyl) (trifluoromethylsulfonyl)amide (LiFTA), lithium bis(pentafluoroethanesulfonyl)imide (LiBETI), lithium-cyclo-difluoromethane-1,1-bis-(sulfonyl)imide (LiDMSI), lithium 4,4,5,5-tetrafluoro-1,3,2-dithiazolidine-1,1,3,3-tetraoxide (LiCTFSI), lithium 1,1,2,2,3,3-hexafluoropropane-1,3-disulfonimide (LiHFDF), lithium perchlorate (LiClO₄), lithium tetrafluoroborate (LiBF₄), lithium hexafluorophosphate (LiPF₆), lithium hexafluoroantimonate (LiSbF₆), lithium trifluoromethanesulfonate (LiTF), lithium 2-trifluoromethyl-4,5-dicyanoimidazolide (LiTDI), lithium tetracyanoborate (LiB(CN)₄), lithium bis(oxalato) borate (LiBOB), lithium difluoro (oxalate) borate (LiDFOB), lithium difluoro (bisoxalato) phosphate (LiDFOP), Li polysulfide, lithium difluorophosphate (LiDFP), other Li-organic salts (e.g., organolithium lithium, alkoxide lithium, amide lithium, imide, thiolate lithium, phosphonate lithium,), and Li-polymer salts (LiFSI-polymer and LiTFSI-polymer), among others. In addition, any of the above-mentioned salts may have their lithium cation replaced with a different metal cation, such as Na, K, Rb, Cs, Mg, Zn, Al, Ag, and In.

The percent weight of these additives with respect to the total weight of the electrolyte may be from 0.05 wt % to 99 wt %, and preferably from 0.25 wt % to 10 wt %. The percent weight of solvent with respect to the total weight of the electrolyte may be from 0.05 wt % to 99 wt %, and preferably from 10 wt % to 90 wt %. The percent weight of the salts with respect to the total weight of the electrolyte may be from 0.05 wt % to 50 wt %, and preferably from 10 wt % to 30 wt %.

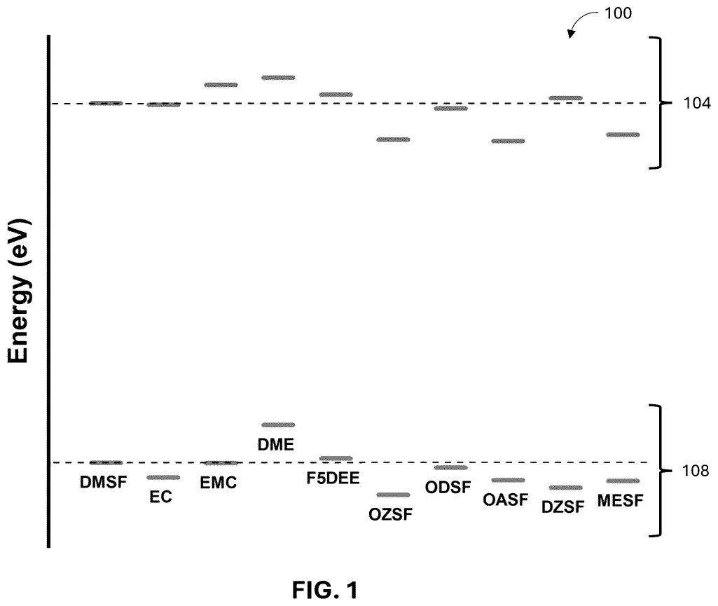

In an energy level diagram 100 shown in FIG. 1, the relative energies of HOMO (highest occupied molecular orbital) 104 and LUMO (lowest unoccupied molecular orbital) 108 of some of the above additives are shown, along with other compounds for comparison. It can be seen that the OZSF, ODSF, OASF, DZSF, and MESF additives have potentially higher oxidative stability compared to DMSF (N, N-dimethylsulfamoyl fluoride), EMC (ethyl methyl carbonate), DME (dimethoxyethane), and F5DEE (2-[2-(2,2-difluoroethoxy) ethoxy]-1,1,1-trifluoroethane). Lower HOMO values (i.e., more negative values) will have potentially higher oxidative stability and therefore may improve the electrolyte stability when charging at, for example, 4 V and above.

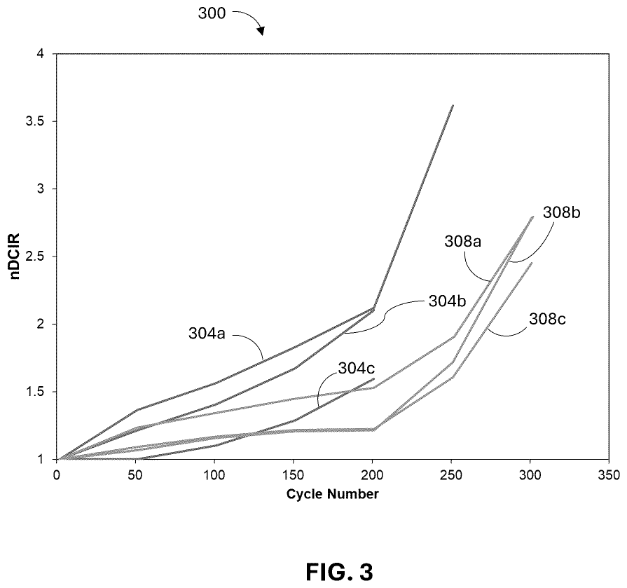

Products from the decomposition of those additives contribute to the formation of solid-electrolyte-interphase (SEI) and cathode-electrolyte-interphase (CEI) with favorable interfacial chemistry and mechanical strength. These additives will decompose during charging based on their thermodynamic potential of the functional group and their overall structures. For example, the S—F bond from sulfonyl fluoride might be broken to form Li—F. These reactions lead to the formation of inorganic-rich decomposition byproducts in the CEI and SEI layers during cycling. Based on direct current internal resistance (DCIR) growth (as can be seen in FIG. 3, for example), electrolyte with OZSF as an additive shows lower DCIR growth rate, which strengthens the total cell impedance that is reduced from the passivation of interface.

In addition, Li metal batteries in particular tend to consume salts from electrolytes, which can lead to drying out of the electrolyte with cycling. Improving salt concentration via the additives disclosed herein can potentially extend cycle life by providing additional salt for the formation of SEI during cycles.

The salt solubility of the above compounds for electrolytes for batteries is suitable in the identified solvent types. For example, the incorporation of OZSF as an additive into DMSF (N,N-dimethylsulfamoyl fluoride) results in the formation of a clear solution and increases the overall salt concentration, as indicated in Table 1, below. A range of 0.25 wt % to 5 wt % OZSF can be combined with DMSF to create an electrolyte containing up to 3.59 M LiFSI salt concentration. This enhancement in LiFSI salt concentration appears to be facilitated by the synergistic interaction between OZSF and DMSF. As the total salt concentration rises, it is likely that a salt-decomposed interface with an inorganic-rich composition forms on both the anode and cathode surfaces. Such an inorganic-rich SEI may exhibit superior ionic conductivity in comparison to polymer-based interfaces. Beyond its impact on salt concentration, OZSF, with its lower HOMO value, may also enhance the oxidative stability of the electrolyte.

TABLE 1
Example solubility of DMSF:OZSF hybrid electrolyte
system containing LiFSI salt

| | LiFSI Salt | weight of | Mole of |
|---|---|---|---|
| | Concentration | OZSF | OZSF |
| Electrolyte Code | (M) | %:DMSF % | %:DMSF % |
| Baseline | 3.09 | 0:100 | 0:100 |
| Hybrid OZSF:DMSF 1 | 3.11 | 0.25:100 | 0.28:100 |
| Hybrid OZSF:DMSF 2 | 3.14 | 0.5:100 | 0.55:100 |
| Hybrid OZSF:DMSF 3 | 3.19 | 1:100 | 1.1:100 |
| Hybrid OZSF:DMSF 4 | 3.29 | 2:100 | 2.2:100 |
| Hybrid OZSF:DMSF 5 | 3.39 | 3:100 | 3.3:100 |
| Hybrid OZSF:DMSF 6 | 3.59 | 5:100 | 5.5:100 |

In another example electrolyte, OZSF is the additive in DMSF with LiFSI salt results in a transparent solution and the total salt concentration is increased over the baseline without the additive as shown in Table 2. With the addition of KFSI, the salt concentration can be increased to 3.86 M. The synergistic effect of KFSI, OZSF and DMSF leads to a salt-derived film forming at both the anode and cathode sides and generates an inorganic-rich interface.

TABLE 2
Example solubility of DMSF:OZSF:KFSI hybrid
electrolyte containing LiFSI salt

| | LiFSI Salt | weight of | Mole of |
|---|---|---|---|
| | Concentration | OZSF %:KFSI | OZSF %:KFSI |
| Electrolyte Code | (M) | %:DMSF % | %:DMSF % |
| Baseline | 3.09 | 0:100 | 0.0:100 |
| Hybrid | 3.28 | 1:3:100 | 1.1:2.5:100 |
| OZSF:KFSI:DMSF 1 | | | |
| Hybrid | 3.86 | 1:4.8:100 | 1.1:4.0:100 |
| OZSF:KFSI:DMSF 2 | | | |

In another example, ODSF is the additive into DMSF solvent with LiFSI salt, which produces a transparent solution and increases the overall salt concentration, as can be seen in Table 3, compared to the baseline electrolyte without the additive. With ODSF supplementation, the total salt concentration can reach up to 4.09 M. The synergistic interaction between ODSF and DMSF promotes the formation of a salt-derived film on both the anode and cathode, resulting in an interface enriched with inorganic components due to the elevated salt concentration. Further, HOMO-LUMO simulations suggest that ODSF may enhance the oxidative stability of the electrolyte.

TABLE 3
Example solubility of DMSF:ODSF hybrid
electrolyte containing LiFSI salt

| | LiFSI Salt | weight of | Mole of |
|---|---|---|---|
| | Concentration | ODSF | ODSF |
| Electrolyte Code | (M) | %:DMSF % | %:DMSF % |
| Baseline | 3.09 | 0:100 | 0:100 |
| Hybrid ODSF:DMSF 1 | 3.39 | 1:100 | 1.2:100 |
| Hybrid ODSF:DMSF 2 | 3.49 | 3:100 | 3.6:100 |
| Hybrid ODSF:DMSF 3 | 3.59 | 5:100 | 6:100 |
| Hybrid ODSF:DMSF 4 | 4.09 | 10:100 | 12:100 |

In another example, DZSF is the additive into DMSF with LiFSI salt, which produces a clear solution and increases the overall salt concentration, as can be seen in Table 4, compared to the baseline electrolyte without the additive. With DZSF supplementation, the total salt concentration can reach up to 3.28 M when the weight ratio of DZSF to DMSF reaches 5%. The synergistic interaction between ODSF and DMSF promotes the formation of a salt-derived film on both the anode and cathode, resulting in an interface enriched with inorganic components due to the elevated salt concentration. Further, HOMO-LUMO simulations suggest that DZSF may enhance the oxidative stability of the electrolyte.

TABLE 4
Example solubility tests of DMSF:DZSF
hybrid system containing LiFSI salt

| | LiFSI Salt | weight of | Mole of |
|---|---|---|---|
| | Concentration | DZSF | DZSF |
| Electrolyte Code | (M) | %:DMSF % | %:DMSF % |
| Baseline | 3.09 | 0:100 | 0.0:100 |
| Hybrid DZSF:DMSF 1 | 3.19 | 1:100 | 1.2:100 |
| Hybrid DZSF:DMSF 2 | 3.19 | 3:100 | 3.6:100 |
| Hybrid DZSF:DMSF 3 | 3.28 | 5:100 | 6.0:100 |

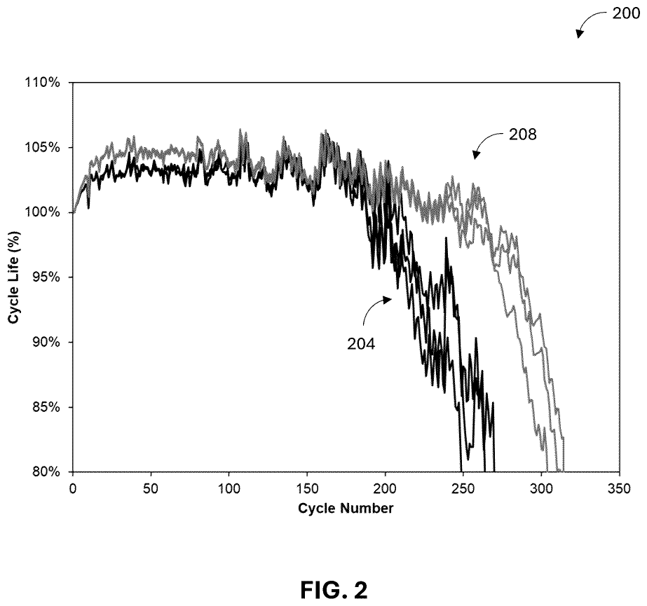

FIG. 2 is a graph 200 of cycle life versus cycle number demonstrating an 18% improvement of cycle number before cycle life percent begins to drop for cells with the integration of OZSF into DMSF-based electrolytes compared to a baseline electrolyte. The results for the baseline electrolyte (labeled 204 in FIG. 2), which contains LiFSI and LiTFSI in DMSF, and the hybrid electrolyte (labeled 208), which contains LiFSI and LiTFSI in DMSF with 0.5 wt % to 5 wt % OZSF, are shown. The C/3-C/3 cycling was tested in 20 μm Li-NMC pouch cells. The LiFSI salt concentration ranges from 2.5 M to 4 M and the LiTFSI salt concentration ranges from 0.1 M to 0.5 M for both the baseline and hybrid electrolyte. The electrolyte amount is from 2 g/Ah to 5 g/Ah. The total cell capacity is from about 300 mAh to about 500 mAh.

FIG. 3 is a graph 300 of nDCIR versus cycle number that illustrates the reduction in nDCIR increases for cells with a hybrid electrolyte compared to cells with a baseline electrolyte as cycle number increases. The results for the baseline electrolyte 304 (304a-304c), which contains LiFSI and LiTFSI in DMSF, and the hybrid electrolyte 308 (308a-308c), which contains LiFSI and LiTFSI in DMSF with 0.5 wt % to 5 wt % OZSF, are shown. The LiFSI salt concentration ranges from 2.5 M to 4 M and the LiTFSI salt concentration ranges from 0.1 M to 0.5 M for both the baseline and hybrid electrolyte. The electrolyte amount is from 2 g/Ah to 5 g/Ah. The total cell capacity is from about 300 mAh to about 500 mAh. In this example, the hybrid electrolyte has DMSF as solvent with OZSF as an additive. The C/3-C/3 cycling was tested in 20 μm Li-NMC pouch cells. As can be seen, the approximate reduction is 19% at 150 cycles, 32% at 200 cycles and 52% at 250 cycles.

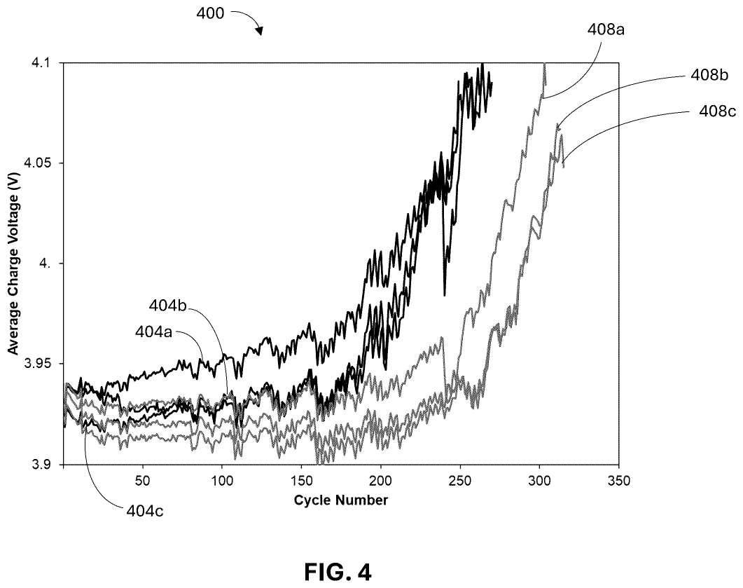

FIG. 4 is a graph 400 of average charge voltage versus cycle number that illustrates the reduction of increases in charge voltage for cells with OZSF integrated into DMSF-based electrolytes compared to cells having a baseline electrolyte without an additive. Results for the baseline electrolyte 404 (404a-404c), which contains LiFSI and LiTFSI in DMSF, and the hybrid electrolyte 408 (408a-408c), which contains LiFSI and LiTFSI in DMSF with 0.5 wt % to 5 wt % OZSF, are shown. The LiFSI salt concentration ranges from 2.5 M to 4 M and the LiTFSI salt concentration ranges from 0.1 M to 0.5 M for both the baseline and hybrid electrolyte. The electrolyte amount is from 2 g/Ah to 5 g/Ah and the total cell capacity is from about 300 mAh to about 500 mAh. The C/3-C/3 cycling was tested in 20 μm Li-NMC pouch cells. The approximate reduction is 0.77% over the first 249 cycles. The beneficial effect of OZSF integration is more apparent in later cycles as the approximate reduction in charge voltage between 200 to 249 cycles is approximately 2.00%.

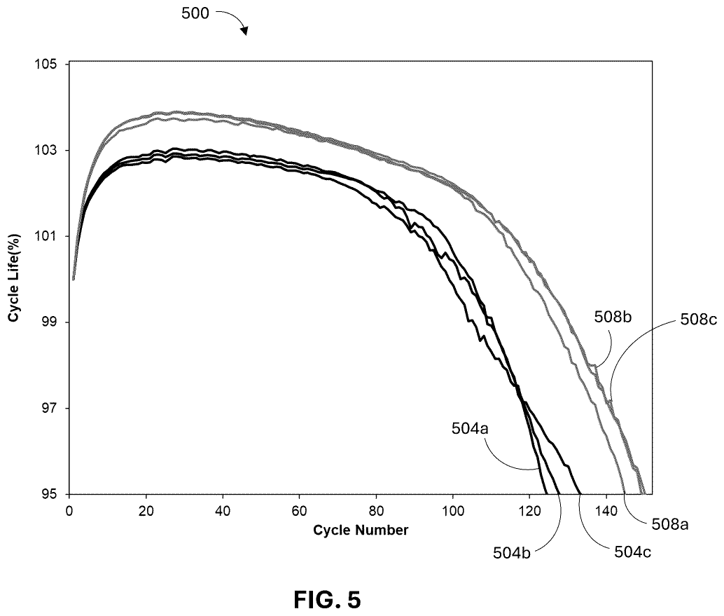

FIG. 5 is a graph 500 of cycle life percent versus cycle number that illustrates a 15.36% improvement of cycle life for cells with an electrolyte with OZSF and KFSI integrated into DMSF solvent compared to cells having a baseline electrolyte with the additive. The 1C-1C cycling was tested in 20 μm Li-NMC pouch cells. The results for the baseline electrolyte 504 (504a-504c), which contains LiFSI and LiTFSI in DMSF, and the hybrid electrolyte 508 (508a-508c), which contains LiFSI and LiTFSI in DMSF with 0.5 wt % to 5 wt % OZSF and 0.5 wt % to 5 wt % KFSI, are shown. The LiFSI salt concentration ranges from 2.5 M to 4 M and the LiTFSI salt concentration ranges from 0.1 M to 0.5 M. The 1C-1C cycling was tested in 20 μm Li-NMC pouch cells. The electrolyte amount is from 2 g/Ah to 5 g/Ah. The total cell capacity is from about 300 mAh to about 500 mAh.

The SEIs formed when the compounds of the present disclosure are used as additives to electrolytes in lithium batteries include a combination of inorganic lithium fluoride (LiF), lithium oxide (Li₂O), and organolithium structures, which contribute to the overall stability and performance of the battery.

In addition to stabilizing the anode, the additives may reduce gas generation, which is a common issue in battery systems, and provides low flammability for enhanced safety. These properties are particularly beneficial for lithium-ion batteries, lithium metal batteries, potassium-ion batteries, and magnesium-ion batteries.

The term “about” when used with a corresponding numeric value refers to ±20% of the numeric value, typically ±10% of the numeric value, often ±5% of the numeric value, and most often ±2% of the numeric value. In some embodiments, the term “about” can be taken as exactly indicating the actual numerical value.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present disclosure. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this disclosure.

Exemplary embodiments have been disclosed above and illustrated in the accompanying drawings. It will be understood by those skilled in the art that various changes, omissions and additions may be made to that which is specifically disclosed herein without departing from the spirit and scope of the present disclosure.

1. An electrolyte for an electrochemical device having an alkali-metal anode having an anode-active material comprising an alkali metal, the electrolyte comprising:
a solvent, the solvent being a carbonate-based, ether-based, or sulfonamide-based solvent;
at least one alkali-metal salt dissolved in the solvent, the alkali-metal salt having a cation comprising the alkali metal of the anode-active material; and
at least one electrolyte additive, each having the following general molecular structure: 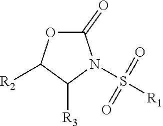
wherein R₁ is selected from the group of —F, —Cl, —Br, —I, —CₙHₘX₂ₙ₊₁₋ₘ, wherein X is F, Cl, Br, or I, n is any value selected from 1 to 3, and m is any value selected from 0 to 2n+1, and wherein R₂ and R₃, are independently selected from any of C₁-C₆ alkyl C_{z}H_{2z+1}, where z is any value from 0 to 6.

2. The electrolyte of claim 1, wherein R₂ and R₃ are any of C₁-C₆ alkyl, C₁-C₆ substituted alkyl, and CₙHₘX₂ₙ₊₁₋ₘZₚ, wherein X is F, Cl, Br, or I and Z is O or S, n is any value from 0 to 6, m is selected from 0 to 2n+1, and p is any value from 0 to n−1.

3. The electrolyte of claim 1, wherein R₂ is the same as R₃.

4. The electrolyte of claim 1, wherein R₂ is the same as R₁.

5. The electrolyte of claim 1, wherein R₁ is —F, R₂ is —H, and R₃ is —H.

6. The electrolyte of claim 1, wherein R₁ is —CF₃, R₂ is —H, and R₃ is —H.

7. The electrolyte of claim 1, wherein the at least one electrolyte additive is present in a range of 0.25 wt % to 5 wt %.

8. The electrolyte of claim 1, wherein the at least one alkali-metal salt is LiFSI and a concentration of the LiFSI is greater than 3.5 M.

9. The electrolyte of claim 1, wherein the solvent is DMSF.

10. The electrolyte of claim 1, wherein the electrolyte additive is one or more of 2-oxo-oxazolidine-3-sulfonyl fluoride (OZSF), oxazolidine-3-sulfonyl fluoride (ODSF), 2-oxo-1,3-oxazinane-3-sulfonyl fluoride (OASF), methyl (fluorosulfonyl)(methyl) carbamate (MEFS), and 1,3,5-dioxazinane-5-sulfonyl fluoride (DZSF).

11. The electrolyte of claim 1, wherein the at least one alkali-metal salt is one or more of lithium sulfonyl imide, lithium bis(fluorosulfonyl)imide (LiFSI), lithium bis(trifluoromethane-sulfonyl)imide (LiTFSI), lithium (fluorosulfonyl)(trifluoromethylsulfonyl)amide (LiFTA), lithium bis(pentafluoroethanesulfonyl)imide (LiBETI), lithium-cyclo-difluoromethane-1,1-bis-(sulfonyl)imide (LiDMSI), lithium 4,4,5,5-tetrafluoro-1,3,2-dithiazolidine-1,1,3,3-tetraoxide (LiCTFSI), lithium 1,1,2,2,3,3-hexafluoropropane-1,3-disulfonimide (LiHFDF), lithium perchlorate (LiClO₄), lithium tetrafluoroborate (LiBF₄), lithium hexafluorophosphate (LiPF₆), lithium hexafluoroantimonate (LiSbF₆), lithium trifluoromethanesulfonate (LiTF), lithium 2-trifluoromethyl-4,5-dicyanoimidazolide (LiTDI), lithium tetracyanoborate (LiB(CN)₄), lithium bis(oxalato)borate (LiBOB), lithium difluoro(oxalate)borate (LiDFOB), lithium difluoro(bisoxalato)phosphate (LiDFOP), Li polysulfide, and lithium difluorophosphate (LiDFP).

12. An electrolyte for an electrochemical device having an alkali-metal anode having an anode-active material comprising an alkali metal, the electrolyte comprising:
a solvent, the solvent being a carbonate-based, ether-based, or sulfonamide-based solvent;
at least one alkali-metal salt dissolved in the solvent, the alkali-metal salt having a cation comprising the alkali metal of the anode-active material; and
at least one electrolyte additive, each having one of the following general molecular structures:
a) 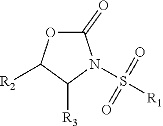
wherein R₁ is selected from the group of —F, —Cl, —Br, —I, —CₙHₘX₂ₙ₊₁₋ₘ (wherein X is F, Cl, Br, or I, n is any value selected from 1 to 3, and m is any value selected from 0 to 2n+1), and wherein R₂, R₃, and R₄ are independently selected from any of C₁-C₆ alkyl or C_{z}H_{2z+1} (wherein z is any value from 0 to 6);
b) 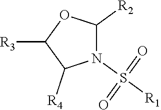
wherein R₁ is selected from the group of —F, —Cl, —Br, —I, —CₙHₘX₂ₙ₊₁₋ₘ (where X is F, Cl, Br, or I, n is selected from 1 to 3, and m is selected from 0 to 2n+1), wherein R₂, R₃, and R₄ are any of C₁-C₆ alkyl CₙH₂ₙ₊₁ (where n is selected from 0 to 6), wherein R₂ or R₃ are any of C₁-C₆ alkyl, C₁-C₆ substituted alkyl, CₙHₘX₂ₙ₊₁₋ₘZₚ (where X is F, Cl, Br, or I and Z is O or S, n is selected from 0 to 6, m is selected from 0 to 2n+1, and p is selected from 0 to n−1), and wherein R₂, R₃ or R₄ is —C₆H₅;
c) 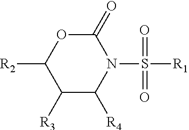
wherein R₁ is selected from the group of —F, —Cl, —Br, —I, —CₙHₘX₂ₙ₊₁₋ₘ (where X is F, Cl, Br, or I, n is selected from 1 to 3, and m is selected from 0 to 2n+1), wherein R₂, R₃, and R₄ are any of C₁-C₆ alkyl or CₙH₂ₙ₊₁ (where n is selected from 0 to 6), wherein R₂ or R₃, can be any of C₁-C₆ alkyl, C₁-C₆ substituted alkyl; CₙHₘX₂ₙ₊₁₋ₘZₚ (where X is F, Cl, Br, or I, Z is O or S, n is selected from 0 to 6, m is selected from 0 to 2n+1, and p is selected from 0 to n−1) and wherein R₂, R₃ or R₄ is —C₆H₅;
d) 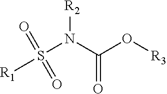
wherein R₁, can be any of —F, —Cl, —Br, —I, —CₙHₘX₂ₙ₊₁₋ₘ (where X is F, Cl, Br, or I, n is selected from 1 to 3, and m is selected from 0 to 2n+1), wherein R₂, R₃, and R₄ are any of C₁-C₆ alkyl, CₙH₂ₙ₊₁ (where n is selected from 0 to 6), wherein R₂ or R₃ can be any of C₁-C₆ alkyl, C₁-C₆ substituted alkyl, CₙHₘX₂ₙ₊₁₋ₘZₚ (where X is F, Cl, Br, or I, Z is O or S, n is selected from 0 to 6, m is selected from 0 to 2n+1, and p is selected from 0 to n−1), and R₂, R₃ or R₄ can be —C₆H₅; or
e) 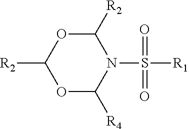
wherein R₁ is selected from the group of —F, —Cl, —Br, —I, and —CₙHₘX₂ₙ₊₁₋ₘ (where X is F, Cl, Br, or I, n is selected from 1 to 3, and m is selected from 0 to 2n+1), wherein R₂, R₃, and R₄ are any of C₁-C₆ alkyl, CₙH₂ₙ₊₁ (where n is selected from 0 to 6), wherein R₂ or R₃ are any of C₁-C₆ alkyl, C₁-C₆ substituted alkyl; CₙHₘX₂ₙ₊₁₋ₘZₚ (where X is F, Cl, Br, or I, Z is O or S, n is selected from 0 to 6, m is selected from 0 to 2n+1, and p is selected from 0 to n−1), and wherein R₂, R₃ or R₄ is, if not one of the above, —C₆H₅.

13. The electrolyte of claim 12, wherein the at least one electrolyte additive is present in a range of 0.25 wt % to 5 wt %.

14. The electrolyte of claim 13, wherein the at least one alkali-metal salt is LiFSI and a concentration of the LiFSI is greater than 3.5 M.

15. The electrolyte of claim 14, wherein the solvent is DMSF.

16. The electrolyte of claim 13, wherein the additive is one or more of 2-oxo-oxazolidine-3-sulfonyl fluoride (OZSF), oxazolidine-3-sulfonyl fluoride (ODSF), 2-oxo-1,3-oxazinane-3-sulfonyl fluoride (OASF), methyl (fluorosulfonyl)(methyl)carbamate (MEFS), and 1,3,5-dioxazinane-5-sulfonyl fluoride (DZSF).

17. The electrolyte of claim 12, wherein the at least one alkali-metal salt is one or more of lithium sulfonyl imide, lithium bis(fluorosulfonyl)imide (LiFSI), lithium bis(trifluoromethane-sulfonyl)imide (LiTFSI), lithium (fluorosulfonyl) (trifluoromethylsulfonyl)amide (LiFTA), lithium bis(pentafluoroethanesulfonyl)imide (LiBETI), lithium-cyclo-difluoromethane-1,1-bis-(sulfonyl)imide (LiDMSI), lithium 4,4,5,5-tetrafluoro-1,3,2-dithiazolidine-1,1,3,3-tetraoxide (LiCTFSI), lithium 1,1,2,2,3,3-hexafluoropropane-1,3-disulfonimide (LiHFDF), lithium perchlorate (LiClO₄), lithium tetrafluoroborate (LiBF₄), lithium hexafluorophosphate (LiPF₆), lithium hexafluoroantimonate (LiSbF₆), lithium trifluoromethanesulfonate (LiTF), lithium 2-trifluoromethyl-4,5-dicyanoimidazolide (LiTDI), lithium tetracyanoborate (LiB(CN)₄), lithium bis(oxalato) borate (LiBOB), lithium difluoro (oxalate) borate (LiDFOB), lithium difluoro (bisoxalato)phosphate (LiDFOP), Li polysulfide, and lithium difluorophosphate (LiDFP).

18. An electrolyte for an electrochemical device having an alkali-metal anode having an anode-active material comprising an alkali metal, the electrolyte comprising:
a solvent, the solvent being a carbonate-based, ether-based, nitrile-based, sulfonated-based, sulfone-based, ionic liquid-based, phosphate-based, or sulfonamide-based solvent;
at least one alkali-metal salt dissolved in the solvent, the alkali-metal salt having a cation comprising the alkali metal of the anode-active material; and
at least one electrolyte additive selected from a compound described herein present in a range of 0.25 wt % to 5 wt % of the electrolyte

19. A method of preparing an electrochemical cell having an alkali-metal anode having an anode-active material comprising an alkali metal, the method comprising:
adding an electrolyte including a solvent, the solvent being a carbonate-based, ether-based, or sulfonamide-based solvent and at least one alkali-metal salt dissolved in the solvent, the alkali-metal salt having a cation comprising the alkali metal of the anode-active material; and
adding at least one additive to the electrolyte, the additive selected such that the additive decomposes to form part of a solid-electrolyte-interphase (SEI) layer and a cathode-electrolyte-interphase (CEI) layer.

20. The method of claim 19, wherein the additive decomposes such that the additive forms 10%-30% of a surface area of the SEI layer and 5%-20% of a surface area of the CEI layer.
